(19) United States
(12) Patent Application Publication
(10) Pub. No.: US 2026/0084302 A1
(43) Pub. Date: Mar. 26, 2026

(54) METHOD FOR DETERMINING MOTION CONSTRAINT PARAMETERS, METHOD FOR DETERMINING POSITION POINTS, METHOD FOR GENERATING MOTION CONTROL SIGNALS, CONTROL METHOD, DEVICE, AND MEDIUM

(71) Applicant: TINAVI MEDICAL TECHNOLOGIES CO., LTD., Beijing (CN)

(72) Inventors: Chongxu LIU, Beijing (CN); Baohui WANG, Beijing (CN)

(73) Assignee: TINAVI MEDICAL TECHNOLOGIES CO., LTD., Beijing (CN)

(21) Appl. No.: 19/407,467

(22) Filed: Dec. 3, 2025

Related U.S. Application Data
(63) Continuation of application No. PCT/CN2025/129252, filed on Oct. 22, 2025.

(30) Foreign Application Priority Data
Sep. 30, 2025 (CN) 202511424017.4

(51) Int. Cl. B25J 9/16; B25J 13/08

(52) U.S. Cl. CPC B25J 9/1653; B25J 9/161; B25J 9/1664; B25J 13/089

(57) ABSTRACT

A method for determining motion constraint parameters, a method for determining position points, a method for generating motion control signals, a control method, a device, and a medium are provided. By acquiring in real time the dynamically changing center position point (third position point) and the end position point (second position point), the total rotation angle and the total radial variation required for moving from the current position point (first position point) to the end position are calculated first. This step establishes the flexible geometric foundation for variable-radius arc motion. Furthermore, by introducing a preset algorithm for solving motion constraint parameters, the above geometric parameters and at least one motion constraint condition (for example, maximum linear velocity) are integrated and collaboratively computed to solve, in real time, a motion constraint parameter.

### CROSS-REFERENCE TO RELATED APPLICATIONS

This application is a continuation of International Patent Application No. PCT/CN2025/129252 with a filing date of Oct. 22, 2025, designating the United States, now pending, and further claims priority to Chinese Patent Application No. 202511424017.4 with a filing date of Sep. 30, 2025. The content of the aforementioned applications, including any intervening amendments thereto, is incorporated herein by reference.

### TECHNICAL FIELD

The present disclosure relates to the technical field of surgical robots, and specifically relates to a method for determining motion constraint parameters, a method for determining position points, a method for generating motion control signals, a control method, a device, and a medium.

### BACKGROUND ART

The motion planning of a surgical robot can be expressed as planning a safe path for the end effector of the robotic arm to move from a starting point to a target operation point based on preoperative imaging data and real-time spatial localization information.

In scenarios where motion planning is executed, and under at least one motion constraint condition, the technical solutions for motion planning in the related art have the technical problem that motion obstacle avoidance is not sufficiently smooth.

### SUMMARY OF THE INVENTION

The purpose of the present disclosure is to overcome the above-mentioned technical shortcomings and to provide a method for determining motion constraint parameters, a method for determining position points, a method for generating motion control signals, a control method, a device, and a medium, so as to solve the technical problem that, in scenarios where motion planning is executed and under at least one motion constraint condition, the technical solutions of motion planning in the related art realize obstacle avoidance that is insufficiently smooth.

To achieve the above technical purpose, the present disclosure adopts the following technical solutions:

According to a first aspect, the present disclosure provides a method for determining motion constraint parameters, it comprises:
acquiring a first position point, a second position point, and a third position point of a current control cycle; wherein the first position point represents the current position point at which a controlled object is located, the second position point represents a target end position point to which the controlled object needs to move, and the third position point represents a center-of-circle position point;
based on the first position point, the second position point, and the third position point, calculating a total rotation angle and a total radius variation required for the controlled object to move from the first position point to the second position point along a variable-radius arc trajectory; and
based on the total rotation angle, the total radius variation, the first position point, the second position point, and a preset algorithm for solving the motion constraint parameters, determining the motion constraint parameters of the current control cycle; wherein the motion constraint parameters are used for calculating a next position point to which the controlled object should move within the current control cycle, and the determination of the motion constraint parameters enables the movement between the next position point and the first position point to satisfy at least one motion constraint condition.

According to a second aspect, the present disclosure provides a method for determining position points, it comprises:
adopting the above-mentioned method for determining motion constraint parameters to calculate the motion constraint parameters of the current control cycle; and
based on the motion constraint parameters, the total rotation angle, the total radius variation, and the third position point, calculating the next position point to which the controlled object should move within the current control cycle.

According to a third aspect, the present disclosure provides a method for generating a motion control signal, comprising:
adopting the above-mentioned method for determining position points to calculate the next position point; and
based on the next position point, generating a motion control signal for controlling the controlled object.

According to a fourth aspect, the present disclosure provides a method for controlling a controlled object, comprising:
adopting the above-mentioned method for generating a motion control signal to generate the motion control signal; and
sending the motion control signal to an actuator of the controlled object to drive the controlled object to move to the next position point.

According to a fifth aspect, the present disclosure provides an electronic device, comprising: a memory, and one or more processors communicatively connected to the memory; wherein the memory stores instructions executable by the one or more processors, and the instructions, when executed by the one or more processors, enable the one or more processors to implement the above-mentioned method.

According to a sixth aspect, the present disclosure provides a computer-readable storage medium, on which a computer program is stored, and when the computer program is executed by a processor, it implements the above-mentioned method.

### Beneficial Effects

The present disclosure, by acquiring in real time the dynamically changing center-of-circle position point (the third position point) and the end position point (the second position point), first calculates the total rotation angle and the total radius variation required for moving from the current position point (the first position point) to the end point, and this step establishes the flexible geometric foundation of variable-radius arc motion. Further, by introducing a preset algorithm for solving the motion constraint parameters, the above geometric parameters and at least one motion constraint condition (for example, maximum linear velocity) are jointly computed in an integrated manner to solve in real time for a motion constraint parameter. The core function of this parameter lies in the fact that it uniquely determines the next position point, and through its mathematical relationships, ensures that the motion process (for example, the displacement) toward that point strictly satisfies the predetermined motion constraint. Accordingly, the present disclosure fundamentally ensures that a robotic arm can always perform obstacle-avoidance tasks in a smooth, continuous, and controlled manner within a dynamic environment, completely solving the problem of insufficient smoothness caused by the decoupling of path and constraints in traditional methods.

### DETAILED DESCRIPTION OF THE DRAWINGS

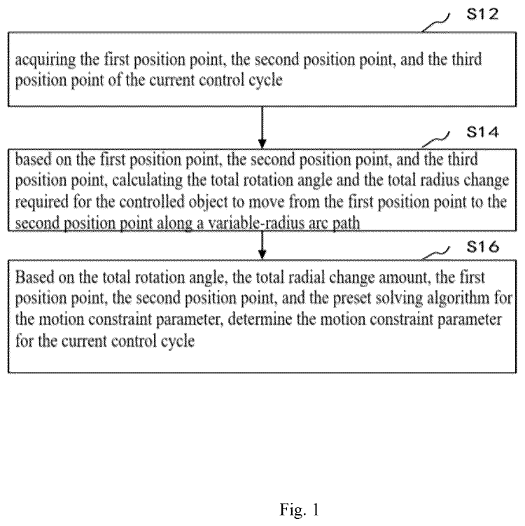

FIG. 1 is a schematic flow diagram of a method for determining motion constraint parameters provided in an embodiment of the present disclosure;

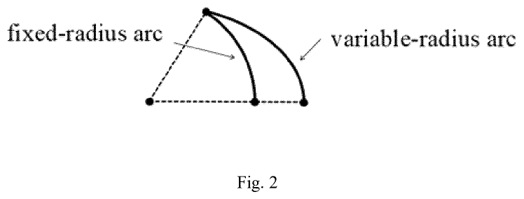

FIG. 2 is a schematic diagram illustrating the difference between a fixed-radius arc and a variable-radius arc provided in an embodiment of the present disclosure;

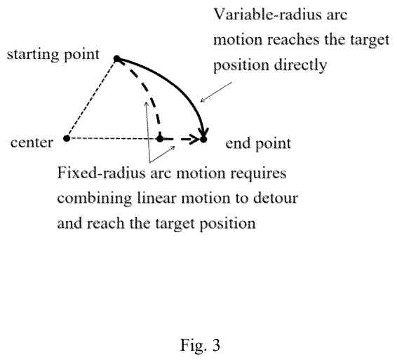

FIG. 3 is a schematic diagram illustrating the advantage of a variable-radius arc in motion efficiency provided in an embodiment of the present disclosure;

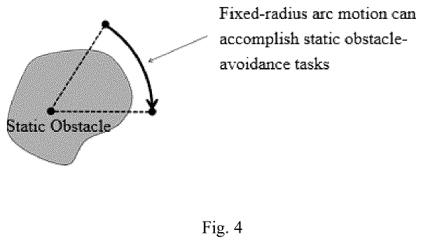

FIG. 4 is a schematic diagram illustrating one of the advantages of a variable-radius arc in dynamic obstacle avoidance provided in an embodiment of the present disclosure;

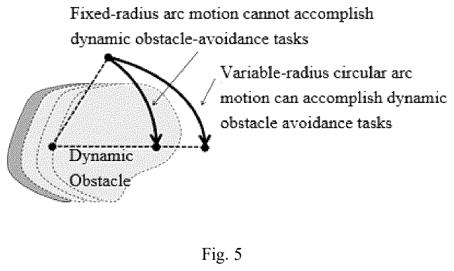

FIG. 5 is a schematic diagram illustrating another advantage of a variable-radius arc in dynamic obstacle avoidance provided in an embodiment of the present disclosure;

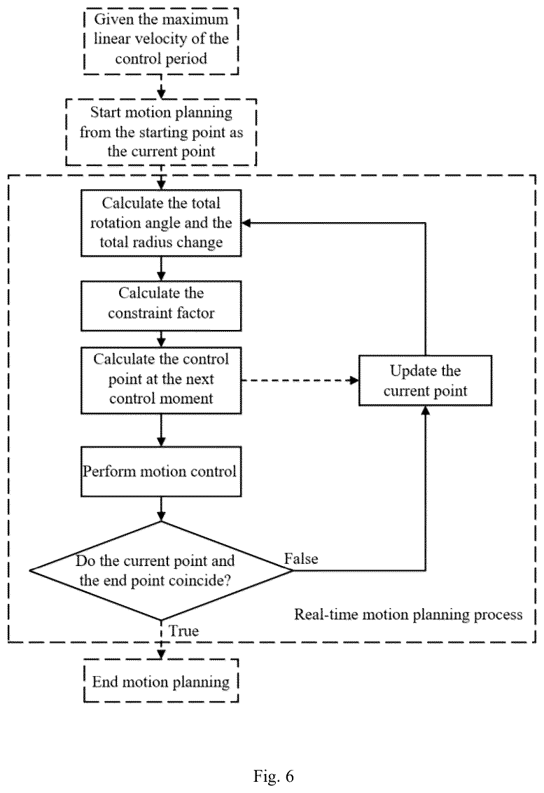

FIG. 6 is a flowchart of a variable-radius arc motion planning method provided in an embodiment of the present disclosure;

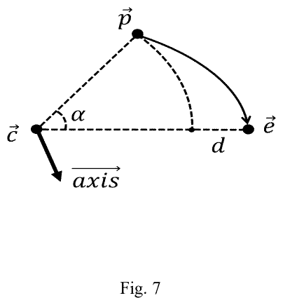

FIG. 7 is a schematic diagram illustrating the calculation of the total rotation angle and total radius variation provided in an embodiment of the present disclosure;

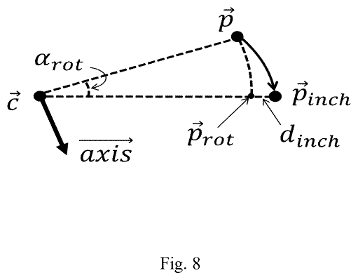

FIG. 8 is a schematic diagram illustrating the calculation of control points provided in an embodiment of the present disclosure;

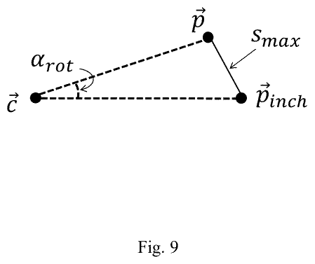

FIG. 9 is a schematic diagram illustrating the calculation of constraint factors provided in an embodiment of the present disclosure;

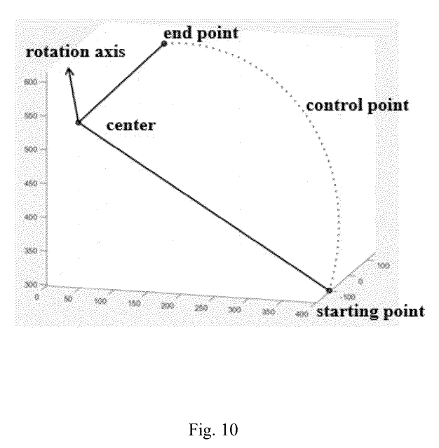

FIG. 10 is a schematic diagram illustrating an actual example provided in an embodiment of the present disclosure; and

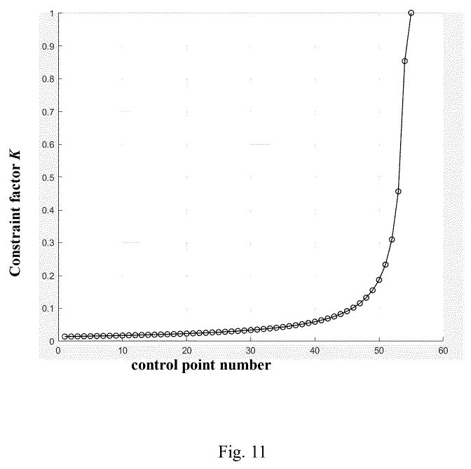

FIG. 11 is a schematic diagram illustrating the values of the constraint factor K corresponding to the control points provided in an embodiment of the present disclosure.

### DETAILED DESCRIPTION OF EMBODIMENTS

In order to enable those skilled in the art to better understand the present application, the technical solutions of the embodiments of the present application will be clearly and completely described below in conjunction with the drawings of the embodiments. It is apparent that the described embodiments are merely part of the embodiments of the present application, and not all embodiments. Based on the embodiments of the present application, all other embodiments obtained by those of ordinary skill in the art without making creative efforts shall fall within the scope of protection of the present application.

In the related art, in a possible motion control system, it may include a path planning module, a motion planning module, and a bottom level motion controller. The path planning module is mainly responsible for generating a geometric path from a starting point to an end point in the task space or configuration space, which can avoid known static obstacles (and may be composed of a series of path points). The motion planning module is responsible for assigning temporal information to the geometric path, that is, based on predetermined motion constraint conditions (which may include maximum linear velocity, maximum acceleration, etc.), it calculates the specific position points (i.e., trajectory points) that the controlled object should reach in each control cycle, and ultimately generates a continuous, smooth motion trajectory that satisfies the kinematic and dynamic constraints. The bottom level motion controller (which may be a joint controller of a robotic arm) receives these trajectory point commands and drives actuators such as motors to achieve precise motion.

Within this framework, in the related art, when addressing scenarios of motion obstacle avoidance, the following deficiencies may exist: First, path planning with a fixed radius lacks flexibility. When encountering dynamically appearing obstacles or when real-time adjustment of the target point is required, it often requires re-performing global path planning, which involves a large computational load and poor real-time performance, leading to motion interruption or delay. Second, even in some solutions that support local adjustment, the generated obstacle-avoidance paths are often forcibly spliced from multiple segments of fixed-curvature arcs and straight lines. Such paths have curvature discontinuities at the junction points, causing the controlled object to frequently accelerate and decelerate during motion, generating vibrations and shocks, i.e., the so-called insufficient smoothness.

Specifically, in a possible technical solution, a method for solving fixed-radius arc trajectories of industrial robots based on spatial analytic geometry is provided. Although it optimizes the efficiency of center-of-circle calculation and reduces computational complexity through vector operations and geometric analysis, its core mechanism has fundamental limitations. The core premise of this technology is that a unique fixed-radius arc trajectory must be determined by three points: a start point, an intermediate point, and an end point. This means that once the arc is determined, its curvature (radius) is constant. In practical applications, when encountering dynamic obstacles or needing to adjust the path shape in real time, this method cannot achieve continuous and smooth variation of the radius. The robot can either move along this fixed arc (with possible collisions) or completely interrupt the current motion and re-invoke the planning algorithm to generate a new fixed arc, making it impossible to achieve a gradually smooth obstacle avoidance effect. Moreover, all calculations of this method are based on three pre-taught target points. This represents a typical offline planning process. In dynamic environments operating in real time, obstacles may move and target points (end points) may change. This technology is completely incapable of handling such dynamic changes because it cannot receive and process new center-of-circle or end point information during motion. Any environmental change means that points must be re-taught and the entire solving process must be re-executed, resulting in motion interruption and failing to meet the real-time requirements of highly dynamic environments.

Specifically, in another possible technical solution, a robot arc motion control scheme is provided, in which the center-of-circle is solved through matrix operations and trajectory planning is performed using quintic polynomial interpolation, while designing a real-time control interface. This technology still relies on a set of fixed points to solve a fixed center and radius through complex matrix operations. Once these three points are determined, the entire arc trajectory is fully determined. This method provides no mechanism to update the center or end point in real time based on sensor feedback after motion begins. Therefore, it also cannot handle dynamic obstacles or moving targets. Its real-time performance is limited to real-time tracking of a predetermined trajectory, rather than real-time replanning of the trajectory itself.

It should be noted that the smoothness achievable by this technology entirely depends on the mathematical continuity of the quintic polynomial interpolation itself (continuous velocity and acceleration). This smoothness is a passive, post-added characteristic used to smooth a pre-defined geometric path that may not be smooth (for example, a fixed arc requiring a sharp turn). True, higher-level “smoothness” should originate from the path shape itself being able to adapt to continuous environmental changes, which is precisely the advantage of a variable-radius arc. This technical solution cannot achieve this fundamental path smoothness.

In summary, a deeper reason lies in that, during the solving process, the motion planning modules in the related art fail to perform integrated, real-time cooperative computation of the geometric path and the kinematic/dynamic constraints. They often handle them separately—that is, first determining a geometric path and then attempting to fit constraints through velocity planning or other methods. In highly dynamic, real-time obstacle-avoidance scenarios, this makes it difficult to simultaneously ensure path optimality and motion smoothness, seriously affecting the performance in high-precision operations (for example, surgical robots).

Therefore, in the related art, in scenarios where motion planning is executed and under at least one motion constraint condition, the technical solutions of motion planning have the technical problem that motion obstacle avoidance is not sufficiently smooth. The present embodiment aims to solve the above problem. The core inventive concept is that, by calculating a unified motion constraint parameter in real time at each control cycle, this parameter simultaneously couples the variations of the geometric path (rotation angle and radius change) with kinematic constraints (maximum linear velocity), and is solved in an integrated manner using a numerical iterative algorithm. As a result, under the strict satisfaction of motion constraints, a smooth and adaptive variable-radius arc obstacle-avoidance trajectory is generated, capable of adapting to dynamic environmental changes.

This embodiment provides a specific scenario example, in which, during robot-assisted knee arthroplasty, the end tool of the surgical robotic arm (for example, a saw blade or a burr) needs to move from an incision point (first position point P) located on the anterior side of the knee bone (femur) to a target operation point (second position point E) located on the posterior side of the knee, in order to perform precise bone cutting. However, a direct linear motion may collide with important ligaments, blood vessels, or unremoved bone tissues. Therefore, the end tool must avoid fragile structures and move along a safe arc path. The rotation center of this arc (third position point C) may be set as the flexion-extension axis of the knee joint (determined jointly by preoperative CT scanning and intraoperative navigation systems). Due to patient-specific anatomical differences and slight intraoperative tissue movements, the required arc radius may need to be adjusted in real time to achieve near-boundary obstacle avoidance, which requires variable-radius arc motion planning.

After the surgery begins, the optical navigation system first tracks the markers on the surgical instruments and the patient's bones in real time. The execution body receives (i.e., acquires) from the navigation system the first position point P (real-time coordinates) of the end tool for the current cycle, the second position point E (target point) set by the planning system, and the third position point C (instantaneous rotation center of the knee joint) calculated from the bone model.

Then, the execution body calculates two key geometric parameters based on the three position points P, C, and E:

The total rotation angle, which is the angle between vector CP and vector CE, indicating the total angle through which the tool needs to rotate around the knee joint axis.

The total radius variation, which is the amount by which the distance from the tool tip to the knee joint axis needs to change from the current point to the target point (it may increase to bypass protruding osteophytes, or decrease to be closer to the bone surface).

It can be understood that, to ensure surgical safety, the execution body sets a maximum linear velocity as a motion constraint to prevent the tool from moving too fast and causing accidental injury.

Finally, the execution body substitutes the total rotation angle, the total radius variation, and other parameters into a preset target equation (which is constructed based on the law of cosines and ensures the relationship between displacement and velocity constraints). Newton's iterative method is used as the solving algorithm to quickly compute the optimal motion constraint parameter K for the current control cycle. This K value is then used to compute the next position point to which the tool tip should move in the next control cycle. This point ensures that, under the strict constraint of not exceeding the maximum safe velocity, the end tool is moving along a smoothly varying arc with a continuously changing radius, precisely and compliantly avoiding obstacles toward the target point E. The above process is repeated in each control cycle (a few milliseconds) until the tool safely reaches the target point E.

As shown in FIG. 1, the present embodiment provides a method for determining a motion constraint parameter. The execution subject of the method may be a processing unit of the robot, which may be an embedded controller, an industrial computer, a dedicated motion control card, or a real-time computing module integrated into the robot system, etc.

In a specific implementation, the execution subject of the method may be a motion-planning controller integrated into the robot system, or more specifically, a dedicated processing module inside it. This dedicated processing module may be computing hardware equipped with a processor and memory, and may be configured to:

A receiving submodule, which is used for acquiring in real time the first position point (current position), second position point (endpoint), and third position point (center of circle) from upstream modules (for example, a path planner, a sensor fusion module, or an external command source).

A computation module, which is used to execute the core algorithm, including calculating the total rotation angle and the total radius change based on the three position points, and running the preset solving algorithm to iteratively determine the motion constraint parameter that satisfies the constraint conditions.

An output module, which sends the calculated motion constraint parameter or the next position point directly solved therefrom to the downstream motion controller (joint servo controller) to drive the actuator (motor) to complete precise motion.

The method may include:

Step S12: acquiring the first position point, the second position point, and the third position point of the current control cycle; wherein the first position point represents the current position point where the controlled object is located, the second position point represents the endpoint position point to which the controlled object needs to move, and the third position point represents the center-of-circle position point.

In this embodiment, the action of acquiring the first position point, the second position point, and the third position point of the current control cycle may specifically be expressed as the execution subject receiving or obtaining the position data through one or a combination of the following ways:

In one possible embodiment, the data may be read from internal memory. Specifically, the execution subject may directly read from pre-stored path-planning data in its internal memory or in shared memory connected thereto the first position point (current position), second position point (endpoint), and third position point (center of circle) that have been calculated or designated in advance for the current control cycle.

In one possible embodiment, the data may be received from external sensors. Specifically, the execution subject may receive data packets collected and transmitted in real time by one or more external sensors (for example, vision sensors, LiDAR, encoders, force/torque sensors) via a communication bus (for example, ROS, EtherCAT, CAN, etc.), and parse from the data packets the first position point, the second position point, and the third position point required for the current control cycle. For example, a vision system may identify and provide the dynamically changing center-of-circle position point (third position point) in real time.

In one possible embodiment, the position data may be parsed from upper-level commands. Specifically, the execution subject may receive real-time motion commands sent by an external control device (for example, an upper-level industrial control computer or a remote operation terminal), within which the respective position points described above are encapsulated. The execution subject then invokes its command-parsing module to solve from the motion command the second position point (endpoint) and/or the third position point (center of circle) designated for the current control cycle. The first position point (current position) may be obtained in real time from the feedback of the robot's joint sensors and calculated through forward kinematics.

In this embodiment, the controlled object may be the end effector of the robotic arm, the robotic arm itself, a position on the robotic arm, or an object (such as a link or joint of the robotic arm), etc.

In this embodiment, the robotic arm may be a robotic arm used in a medical scenario, for example, a surgical robot. It can be understood that in a surgical robot system, the robotic arm, as the core execution mechanism, may be equipped with various high-precision surgical tools (such as an endoscope, electrocautery knife, suturing tool, or orthopedic drill). In this scenario, the motion planning of the robotic arm must meet extremely high requirements for safety, stability, and precision. By applying the method described in this embodiment, the end effector of the surgical robot can follow a smooth and compliant trajectory to bypass key anatomical structures (for example, blood vessels and nerves) or skeletal structures within the human body and accurately reach the lesion area, thereby greatly improving surgical safety and operational fluency.

In this embodiment, the robotic arm may also be a general-purpose or heavy-duty robotic arm used in industrial scenarios. For example, in automobile manufacturing, a painting robot needs to cover complex curved surfaces with a continuous and uniform trajectory; in warehousing and logistics, a handling robot needs to flexibly avoid obstacles among dense shelves.

In this embodiment, the first position point may represent the actual three-dimensional coordinate position of the controlled object (the robotic arm's end effector) in its working-space coordinate system at the start moment of the current control cycle. The first position point may be a dynamically changing parameter.

In this embodiment, the second position point may represent the three-dimensional coordinate position, in the working-space coordinate system, of the target position point that the controlled object needs to eventually reach within the current control cycle. This point defines the final target of the current motion segment. Specifically, the second position point may be a global path point preset by an upstream path-planning module, a target point determined in real time based on an external task command (for example, “grasp an object”), or a dynamically updated obstacle-avoidance target point perceived in real time by a sensor (for example, a vision system).

In this embodiment, the third position point may represent the three-dimensional coordinate position, in the working-space coordinate system, of a reference center-of-circle point designated within the current control cycle for defining the variable-radius arc motion path. It can be understood that the third position point may be a fixed point preset in advance, or a dynamic safety point provided by a sensor for obstacle avoidance.

Step S14: based on the first position point, the second position point, and the third position point, calculating the total rotation angle and the total radius change required for the controlled object to move from the first position point to the second position point along a variable-radius arc path.

In this embodiment, the total rotation angle may represent the total angular value (in radians) by which the position vector needs to rotate around the third position point (center of circle) during the entire process of moving from the first position point (current position) at the beginning of the current control cycle to the second position point (endpoint). This angle is a scalar, and its value equals the angle between the vector from the center to the current point and the vector from the center to the endpoint. Geometrically, the total rotation angle defines the total amount of rotation required to complete the movement from the current point to the target point, serving as the global planning objective in the angular dimension for the entire motion. This value gradually decreases as the motion progresses until it becomes zero, indicating that the rotation is completed.

In this embodiment, the total radial change amount may be represented as the total amount by which the magnitude (i.e., the distance) of the position vector relative to the third position point (the circle center) needs to change throughout the process of moving from the first position point (the current position at the beginning of the present control cycle) to the second position point (the endpoint). The numerical value of the total radial change amount is equal to the distance from the endpoint to the circle center minus the distance from the current point to the circle center. It may be an algebraic quantity, which may be positive or negative. A positive value indicates that the radius needs to be increased (moving away from the circle center) during the movement process, while a negative value indicates that the radius needs to be reduced (moving toward the circle center). Geometrically, it defines the total amount of radial extension or contraction required to complete the movement from the current point to the target point, and represents the global planning objective in the radial dimension for the entire movement.

Step S16: Based on the total rotation angle, the total radial change amount, the first position point, the second position point, and the preset solving algorithm for the motion constraint parameter, determine the motion constraint parameter for the current control cycle; wherein the motion constraint parameter is used to calculate the next position point to which the controlled object should move within the current control cycle, and determining the motion constraint parameter ensures that the movement between the next position point and the first position point satisfies at least one motion constraint condition.

In this embodiment, the motion constraint parameter may be represented as a scalar proportional factor between 0 and 1, which may be denoted as K. This motion constraint parameter is the core output of the present method, and its physical meaning lies in decomposing the macroscopic, global motion task into microscopic motion commands that are to be executed within the current control cycle in proportion.

Specifically, the numerical value of the motion constraint parameter is the optimization target of the preset solving algorithm for the motion constraint parameter. This algorithm is used to search for an optimal K value such that the next position point computed according to this value, under the premise that the geometric path from the current point to the next point is a variable-radius circular arc, has kinematic characteristics (e.g., instantaneous displacement, velocity, acceleration, etc.) that strictly satisfy the at least one motion constraint condition (e.g., maximum linear velocity constraint).

It can be understood that since the motion constraint parameter needs to be recalculated in each control cycle, its value will be adaptively adjusted as the motion proceeds (the current point approaches the endpoint) and as the environment changes (the circle center and endpoint are dynamically updated). This process ensures that even when external conditions change, the executing body can still generate optimal motion commands in real time that both satisfy the path requirements and comply with the motion constraints.

In this embodiment, the motion constraint conditions may include a maximum linear velocity constraint, maximum angular velocity constraint, maximum linear acceleration constraint, maximum angular acceleration constraint, or maximum jerk constraint.

It can be understood that the maximum linear velocity, maximum angular velocity, maximum linear acceleration, maximum angular acceleration, and maximum jerk in the maximum linear velocity constraint, maximum angular velocity constraint, maximum linear acceleration constraint, maximum angular acceleration constraint, or maximum jerk constraint may be limit values supported by the robotic arm corresponding to the executing body (i.e., hardware upper limits), or may be preset values flexibly configured by the user (different application scenarios may require different settings).

For example, in a surgical robot application scenario, when the robotic arm moves near high-risk regions such as important nerves, blood vessels, or the retina, extremely conservative parameter preset values may be applied. For instance, the maximum linear velocity may be set to a low value (e.g., 1-2 mm/s), and the maximum jerk must be strictly limited to ensure extremely smooth and slow movement of the end-effector, thereby avoiding irreversible damage to fragile tissue caused by excessive instantaneous acceleration or sudden motion changes. When the surgical instrument moves in low-risk regions (e.g., adipose tissue or muscle gaps), it may switch dynamically to relatively relaxed parameter preset values.

In this embodiment, the preset solving algorithm for the motion constraint parameter may be an optimization-based solving algorithm. Specifically, the solving of the motion constraint parameter may be transformed into a miniature optimization problem, which may be solved online using an optimization algorithm.

In a specific implementation, the preset solving algorithm for the motion constraint parameter may be pre-constructed as follows:

The decision variable: the motion constraint parameter may be used as the decision variable to be optimized.

The objective function: an objective function (loss function) may be defined for minimization. The core of this function is to measure the difference between the motion state computed from the motion constraint parameter and the predetermined expected state.

For this optimization problem, different types of optimization algorithms may be used for online solving. Specifically, under certain conditions (for example, when the objective function and the constraint conditions can be transformed into convex functions through mathematical transformations), the optimization problem may be modeled as a convex optimization problem (for example, a quadratic programming problem). In this case, a convex optimization solver (for example, an interior-point method) may be invoked for solving. Specifically, for complex scenarios in which the objective function exhibits strong nonlinearity, non-convexity, or contains multiple local extrema, global optimization algorithms such as genetic algorithms or particle swarm optimization algorithms may be used as the optimization method.

In this embodiment, the preset solving algorithm for the motion constraint parameter may be a data-driven solving algorithm based on machine learning or deep learning. Specifically, through offline training or online learning, a fast mapping relationship can be established from the input parameters (such as the total rotation angle, total radial change amount, current position, etc.) to the motion constraint parameter, thereby avoiding the time overhead caused by online iterative computation.

In a specific embodiment, a lightweight neural network (for example, an MLP or CNN) may be employed and trained using historical motion data or simulation data to achieve end-to-end rapid inference.

In a specific embodiment, the entire motion planning process may be modeled as a Markov decision process. The agent (executing body) learns a policy that can directly output an action (i.e., the K value) based on the current state (for example, the current position, the endpoint, and the circle center), in order to maximize cumulative rewards (the reward function may be set to: satisfying constraints, fast arrival, low energy consumption, etc.).

In this embodiment, the preset solving algorithm for the motion constraint parameter may be a table-lookup-based solving algorithm. Specifically, in the offline phase, a multi-dimensional lookup table may be predefined, with its dimensions including: total rotation angle (after quantization), total radial change amount (after quantization), current radius (after quantization), and maximum allowable displacement (after quantization). For each grid point corresponding to a combination of dimension values, an optimal K value may be determined in advance through computation or experimentation and stored in the table. During the online phase, based on the actual total rotation angle, total radial change amount, current radius, and maximum allowable displacement, a near-optimal K value satisfying the constraints may be rapidly obtained through table lookup combined with interpolation (for example, bilinear or trilinear interpolation).

In a specific embodiment, the preset solving algorithm for the motion constraint parameter may be a solving algorithm pre-constructed with respect to an objective equation related to the motion constraint parameter and configured to perform iterative solving for this objective equation. The objective equation may be constructed such that its solution is the motion constraint parameter, and under the constraint of the motion constraint parameter, the kinematic relationship of the controlled object moving from the first position point to the next position point satisfies at least one motion constraint condition. In the case where the motion constraint condition is a maximum linear velocity constraint, the objective equation is constructed to characterize the following relationship: under the effect of the motion constraint parameter, the displacement generated by moving from the first position point to the next position point has a magnitude equal to the product of the predetermined maximum linear velocity and the control cycle. The geometric relationship among the magnitude of the displacement, the total rotation angle, and the total radial change amount is determined based on the side-angle relationships of the triangle formed by the first position point, the third position point, and the next position point.

Specifically, the expression of the objective equation may be:

$${s}_{max}^{2} = 2 * ‖ \vec{cp} ‖ * ( ‖ \vec{cp} ‖ + k * d ) * ( 1 - cos ( k * α ) ) + {( k * d )}^{2}$$

where sₘₐₓ is the maximum allowable displacement, representing the constraint boundary; ∥c̅p̅∥ is the current radius, i.e., the Euclidean distance from the current point to the circle center; d is the total radial change amount; α is the total rotation angle; and K is the motion constraint parameter.

In a specific embodiment, in the case where the motion constraint condition is only the maximum angular velocity constraint, the objective equation may be constructed as:

$$k \cdot α = {ω}_{max} \cdot Δ t$$

where ωₘₐₓ is the maximum angular velocity; Δt is the control cycle; K is the motion constraint parameter; and α is the total rotation angle.

It can be understood that this objective equation ensures that the angular velocity of the controlled object rotating around the circle center does not exceed the preset maximum value ωₘₐₓ. It can also be understood that although this objective equation explicitly involves only the rotation angle, the parameter K simultaneously governs the radial change (d_{inch}=k·d), such that rotation and radial variation are handled synchronously. The solution K guarantees compliance with the angular velocity constraint, while the radial change is intrinsically adapted.

In a specific embodiment, in the case where the motion constraint condition is only the maximum linear acceleration constraint, the objective equation may be constructed as:

$${‖ {\vec{p}}_{inch} - \vec{p} ‖}^{2} = 2 \cdot ‖ \vec{cp} ‖ \cdot ( ‖ \vec{cp} ‖ + k \cdot d ) \cdot ( 1 - cos ( k \cdot α ) ) + {( k \cdot d )}^{2}$$

where ∥\vec{p}_{inch}−\vec{p}∥² denotes the square of the displacement, i.e., the squared norm of the displacement vector produced when the controlled object moves from the current point P to the next point Pinch within one control cycle; ∥\vec{cp}∥ is the current radius, i.e., the Euclidean distance from the current point to the circle center; d is the total radial change amount; α is the total rotation angle; and K is the motion constraint parameter.

Since the linear acceleration constraint must be based on the kinematic model considering velocity change, assuming that the current linear velocity is v_{current} (obtained from the previous cycle), the acceleration constraint may be expressed as:

$$\vert \frac{{v}_{next} - {v}_{current}}{Δ t} \vert \leq {a}_{max}$$

where aₘₐₓ is the maximum linear acceleration; vₙₑₓₜ is the velocity in the next cycle, which may be approximated by

$${v}_{next} = \frac{‖ {\vec{p}}_{inch} - \vec{p} ‖}{Δ t} ;$$

and the displacement ∥\vec{p}_{inch}−\vec{p}∥ is a function of K. Therefore, the objective equation may be further converted into:

$$\vert \frac{\sqrt{2 \cdot ‖ \vec{cp} ‖ \cdot ( ‖ \vec{cp} ‖ + k \cdot d ) \cdot ( 1 - cos ( k \cdot α ) ) + {( k \cdot d )}^{2}} - {v}_{current} \cdot Δ t}{Δ {t}^{2}} \vert \leq {a}_{max}$$

The preset solving algorithm may perform iterative solving for the above objective equation, ensuring that the linear acceleration constraint is satisfied while simultaneously handling rotation and radial change.

In a specific embodiment, in the case where the motion constraint condition is only the maximum jerk constraint, the objective equation may be constructed as follows:

The jerk constraint involves the derivative of acceleration. Assuming that the current acceleration is a_{current} (obtained from the previous cycle), the jerk constraint is:

$$\vert \frac{{a}_{next} - {a}_{current}}{Δ t} \vert \leq {j}_{max}$$

where jₘₐₓ is the maximum jerk constraint and is used to ensure smooth variation of acceleration. Limiting jerk effectively reduces impact, vibration, and mechanical wear. a_{current} is the acceleration obtained in the previous cycle; aₙₑₓₜ is the acceleration in the next cycle, which can be approximated through second-order finite differences of the displacement.

Since the displacement s(k)=∥\vec{p}_{inch}−\vec{p}∥ is a function of K (same as above), the acceleration aₙₑₓₜ may be expressed as:

$${a}_{next} = \frac{2 \cdot ( s ( k ) - {v}_{current} \cdot Δ t )}{Δ {t}^{2}} - {a}_{current}$$

Substituting into the constraint condition, the objective equation becomes:

$$\vert \frac{\frac{2 \cdot ( s ( k ) - {v}_{current} \cdot Δ t )}{Δ {t}^{2}} - {a}_{current} - {a}_{current}}{Δ t} \vert \leq {j}_{max}$$

It can be understood that the objective equation associates s(k) with K, converting the jerk constraint into an iterative solving problem with respect to K, while simultaneously incorporating the effects of rotation and radial variation.

In a specific embodiment, when multiple constraints need to be satisfied simultaneously, the objective equation may be constructed as a multi-objective optimization problem. Specifically, the constraint conditions may be:

$$\{ \begin{matrix}‖ {\vec{p}}_{inch} - \vec{p} ‖ = {v}_{max} \cdot Δ t \\ \vert \frac{{v}_{next} - {v}_{current}}{Δ t} \vert \leq {a}_{max}\end{matrix}$$

where vₘₐₓ is the maximum linear velocity constraint, aₘₐₓ is the maximum linear acceleration constraint, and ∥\vec{p}_{inch}−\vec{p}∥ may be expressed as a function of K. By substituting

$${v}_{next} = \frac{‖ {\vec{p}}_{inch} - \vec{p} ‖}{Δ t} ,$$

the objective equation may be obtained as:

$$\{ \begin{matrix}\sqrt{2 \cdot ‖ \vec{cp} ‖ \cdot ( ‖ \vec{cp} ‖ + k \cdot d ) \cdot ( 1 - cos ( k \cdot α ) ) + {( k \cdot d )}^{2}} - {v}_{max} \cdot Δ t \\ \vert \frac{\sqrt{2 \cdot ‖ \vec{cp} ‖ \cdot ( ‖ \vec{cp} ‖ + k \cdot d ) \cdot ( 1 - cos ( k \cdot α ) ) + {( k \cdot d )}^{2}} - {v}_{current} \cdot Δ t}{Δ {t}^{2}} \vert \leq {a}_{max}\end{matrix}$$

In this embodiment, by acquiring in real time the dynamically changing circle-center position point (third position point) and the endpoint position point (second position point), the system first computes the total rotation angle and the total radial change amount required for moving from the current position point (first position point) to the endpoint. This step establishes the flexible geometric basis of the variable-radius circular-arc motion. Subsequently, by introducing the preset motion-constraint-parameter solving algorithm, the above geometric parameters and at least one motion constraint condition (for example, maximum linear velocity) are jointly and integratively computed, so that a motion constraint parameter is solved in real time. The core function of this parameter is that it uniquely determines the next position point, and its mathematical relationship ensures that the motion process (for example, displacement) toward this point strictly satisfies the predetermined motion constraint. Consequently, this fundamentally ensures that the manipulator can always perform obstacle-avoidance tasks in a smooth, continuous, and controlled manner in dynamic environments, completely resolving the non-smooth-motion problem in traditional methods caused by fixed paths and decoupled constraint solving.

In some embodiments, the step of acquiring the first position point, the second position point, and the third position point in the current control cycle includes:

Reading the first position point, the second position point, and the third position point of the current control cycle from path-planning data stored in advance in memory.

In this embodiment, before executing the motion task, the global path of the entire motion (including a sequence of circle-center points and target points) has already been computed by the upstream path-planning algorithm and stored as a complete dataset in the internal memory of the execution body. During the motion process, the execution body only needs to read the three required position points for the current control cycle from the memory space according to a predetermined order or logic.

Or, receiving the first position point, the second position point, and the third position point of the current control cycle collected and transmitted by at least one external sensor.

In this embodiment, the external sensors (for example, vision cameras, LiDAR, ultrasonic sensors, etc.) continuously perceive and model the working environment of the robot. They send the real-time processed information (for example, recognized dynamic target points, estimated safe circle-center points) to the execution body through the communication bus. The execution body receives these data packets and parses out the position information required for the current cycle.

Or, receiving real-time position commands sent from an external control device, and then parsing from the real-time position commands the first position point, the second position point, and the third position point of the current control cycle.

In the present embodiment, the execution entity may be configured in a master-slave control architecture. In this architecture, the execution entity acts as a slave unit and receives real-time control commands issued by an upper-level master control device (for example, an industrial computer, a server, an operation console, etc.). The real-time control command encapsulates the user-specified task intention (for example, “move to point A”, “rotate around point B”). The execution entity decodes the received command and extracts the specific position targets (the second position point and the third position point) required for execution in the current control cycle. The first position point (the current position) may still be obtained from the robot's own feedback.

The present embodiment provides multiple heterogeneous data acquisition paths, enabling the method for determining the motion constraint parameter to flexibly adapt to various application scenarios ranging from static pre-planning to highly dynamic real-time sensing, thereby significantly enhancing the practicality, robustness, and integration convenience of the solution. It supports efficient offline computation based on a pre-known path, can cope with dynamically changing environments through integrated real-time sensor feedback, and can also be seamlessly integrated as a subsystem into a larger external control framework to receive real-time scheduling. Thus, under various actual deployment conditions, the subsequent computation modules can always receive reliable, diverse, and timely position data inputs.

In some embodiments, the step of computing, based on the first position point, the second position point, and the third position point, the total rotation angle and the total radius variation required for the controlled object to move from the first position point to the second position point along a variable-radius arc path includes:

Step S142: Calculating a first vector from the third position point to the first position point, and calculating a second vector from the third position point to the second position point.

Step S144: Calculating the total rotation angle based on the magnitude of the cross product and the dot product of the first vector and the second vector.

Step S146: Calculating the difference between the magnitude of the second vector and the magnitude of the first vector to obtain the total radius variation.

In this embodiment, by constructing two vectors from the arc center to the current point and to the target point, respectively, and by precisely computing the total rotation angle based on their cross product and dot product, while directly obtaining the total radius variation from the difference between the magnitudes of the two vectors, the method converts complex spatial geometric relationships into a series of rigorous vector operations. This not only ensures mathematical accuracy and clear physical meaning, but also provides a reliable geometric foundation for the subsequent solving of the motion constraint parameter. Furthermore, due to its highly programmable and computationally efficient nature, with a fixed and lightweight computational load, this method is well suited for stable operation in the real-time control loop of a robot, thereby ensuring the real-time performance and reliability of the entire motion planning system.

In some embodiments, the step of determining the motion constraint parameter of the current control cycle based on the total rotation angle, the total radius variation, the first position point, the second position point, and a preset motion-constraint-parameter solving algorithm includes:

Step S162: Inputting the total rotation angle, the total radius variation, the first position point, and the second position point into a pre-constructed target equation of the motion constraint parameter; wherein the target equation is constructed such that the solution of the target equation is the motion constraint parameter, and that, under the constraint of the motion constraint parameter, the kinematic relationship of the controlled object moving from the first position point to the next position point satisfies at least one motion constraint condition.

In this embodiment, the target equation may be a target equation satisfying a single motion constraint condition, or may be a target equation simultaneously satisfying multiple motion constraint conditions. Specifically, the target equation establishes a mathematical relationship between the motion constraint parameter K and the at least one motion constraint condition.

When the motion planning requires satisfying only a primary motion constraint, the target equation is typically constructed as a single-variable equation for solving K, aiming to actively satisfy the motion constraint (usually by equality, to maximize motion efficiency). For example: Maximum linear velocity constraint, aimed at limiting the linear velocity of the end-effector. The target equation is constructed based on the law of cosines to ensure the relationship between displacement and the velocity constraint. For example: Maximum angular velocity constraint: aimed at limiting the angular velocity of rotation around the arc center. The target equation directly constrains the angular displacement.

Specifically, the target equation may be a target equation that simultaneously satisfies multiple motion constraint conditions. It can be understood that when multiple motion constraint conditions need to be satisfied at the same time, it is often difficult to find a single K value that allows all motion constraint conditions to simultaneously reach their limit values. Therefore, the target equation may be constructed as an optimization problem, whose objective is to find an optimal K value that, while giving priority to satisfying certain constraints, approaches as closely as possible the limit values of the other constraints. Thus, in this case, the target equation may be constructed in the form of a loss function, and numerical optimization algorithms (for example, gradient descent, Newton's method, etc.) may be used to search for the K value that minimizes the loss function.

It can also be understood that, regardless of whether the target equation is used for a single constraint or multiple constraints, its essence is to transform kinematic limitations into a mathematical problem with respect to the core parameter K. By solving this problem, an optimal balance point between complex geometric path variation (rotation and radius variation) and various kinematic performance requirements can be found.

In the present embodiment, the kinematic relationship of the controlled object moving from the first position point to the next position point may be a dynamic kinematic relationship during the motion process (for example, velocity-domain kinematic relationships, acceleration-domain kinematic relationships, jerk-domain kinematic relationships), or may also be a static kinematic relationship (for example, displacement-domain kinematic relationships). The kinematic relationship may be expressed as the motion laws and characteristics, measurable by physical quantities, that the controlled object follows during the motion process from the first position point to the next position point.

Step S164: adopting a preset solving algorithm to solve the target equation to obtain the motion constraint parameter of the current control cycle.

In the present embodiment, the preset solving algorithm may be a gradient-based iterative optimization algorithm, that is, an optimization algorithm that conducts efficient searching using derivative information of the target function. Specifically, it may be gradient descent, Newton's iterative method, or quasi-Newton methods, etc.

In the present embodiment, the preset solving algorithm may be a derivative-free iterative searching algorithm, that is, when the target function is non-differentiable or the cost of differentiation is too high, a derivative-free iterative searching algorithm depending only on function-value comparison may be adopted. Specifically, it may be the bisection method, or the golden-section method, etc.

In the present embodiment, the preset solving algorithm may be an intelligent optimization algorithm, that is, when the target equation is extremely complex (highly nonlinear) or when minimizing a loss function involving multiple constraint conditions is required, an algorithm with global searching capability may be adopted. Specifically, it may be a genetic algorithm, or a particle swarm optimization algorithm, etc.

In the present embodiment, the preset solving algorithm may be a lookup-table and interpolation method.

In the present embodiment, the preset solving algorithm may be a data-driven optimization algorithm, for example, an optimization algorithm based on neural-network regression.

The present embodiment, by transforming the complex multi-constraint motion planning problem into a solving problem of a target equation based on rigorous mathematical definitions, and by using numerical iterative algorithms for efficient computation, successfully integrates the two traditionally separate steps—geometric path planning and satisfaction of kinematic constraints-into a unified, closed-loop optimization process. This method not only fundamentally ensures that the generated next position point strictly complies with all preset motion constraints (maximum linear velocity), guaranteeing motion accuracy and safety, but also achieves excellent real-time computational performance due to its deterministic mathematical formulation and efficient solving algorithms, thereby enabling reliable online, real-time compliant control of motion in highly dynamic environments.

In some embodiments, the motion constraint conditions include: maximum linear velocity constraint, maximum angular velocity constraint, maximum linear acceleration constraint, maximum angular acceleration constraint, or maximum jerk (acceleration derivative) constraint.

The present embodiment, by explicitly defining that the motion constraint conditions may cover multiple dimensions and levels including displacement, velocity, acceleration, and jerk (including both linear and rotational motion), enables the method for determining the motion constraint parameter to adapt to a wide range of application scenarios, from simple point-to-point motion to high-performance precision trajectory tracking. Its beneficial effects lie in significantly enhancing the customizability and granularity of motion planning by providing a rich set of selectable constraint conditions, so that the controlled object can not only efficiently complete spatial displacement tasks, but also move in a smooth, stable, and dynamically controlled manner, thereby effectively suppressing vibration and impact, and improving safety, stability, and reliability in complex applications such as high-speed motion, high-precision operations, or human-robot collaboration.

In some embodiments, adopting the preset solving algorithm includes: gradient-based iterative optimization algorithms, derivative-free iterative searching algorithms, optimization algorithms with global searching capability, lookup-table and interpolation methods, or data-driven optimization algorithms.

The present embodiment, by providing multiple optional solving algorithms ranging from high-precision iterative methods to efficient lookup methods, and from classical optimization to artificial-intelligence-based approaches, endows the method for determining the motion constraint parameter with excellent computational adaptability and system compatibility. Its beneficial effect lies in the ability to flexibly select the most suitable solving strategy according to different application scenarios (with stringent requirements on real-time performance, precision, or computational resources), thereby enabling reliable deployment and efficient operation on heterogeneous hardware platforms such as embedded devices, industrial controllers, and even high-performance computing units.

In some embodiments, in the case where the motion constraint condition is the maximum linear velocity constraint, the target equation is constructed to characterize the following relationship:

Under the action of the motion constraint parameter, the displacement generated when moving from the first position point to the next position point has a magnitude equal to the product of the predetermined maximum linear velocity and the control period; wherein the geometric relationship among the magnitude of the displacement, the total rotation angle, and the total radius variation is determined based on the side-angle relationships of the triangle formed by the first position point, the third position point, and the next position point.

In this embodiment, the maximum linear velocity constraint requires that the instantaneous linear velocity of the controlled object during the motion process shall not exceed a preset value (which may be the maximum value supported by the device or may be a dynamically preset value adaptable to different scenarios). That is, by discretizing the planning process using one control period as the time unit, this constraint can be expressed within a single control period as follows: the magnitude of the displacement generated when moving from the first position point to the next position point must be less than or equal to the maximum linear velocity multiplied by the control period. The significance of solving this equation lies in finding an appropriate K value, such that when the next position point is generated according to this K value, the displacement from the current position point to the next position point exactly equals the allowable maximum displacement, thereby ensuring that within the control period, the average linear velocity exactly equals the allowable maximum linear velocity.

In this embodiment, by converting the abstract motion constraint (maximum linear velocity) into a concrete mathematical equation based on geometric triangular relationships, the satisfiability of the constraint can be precisely verified and solved through rigorous mathematical operations. Its beneficial effect lies in successfully transforming the velocity constraint problem in kinematics into a purely geometric spatial relationship problem. This not only ensures that the next position point calculated based on the motion constraint parameter strictly satisfies the core constraint “displacement=maximum linear velocity×control period,” thereby ensuring motion efficiency and controllability, but also, due to the clarity and definiteness of its mathematical model, provides a solid foundation for subsequently adopting efficient and stable numerical iterative algorithms for real-time solving, greatly improving the reliability and real-time performance of the entire motion planning process.

In some embodiments, the step of solving the target equation using a preset solving algorithm to obtain the motion constraint parameter for the current control period includes:

Step S1642: initializing the iterative initial value of the motion constraint parameter.

In this embodiment, Ki may be set as the iteration variable, with its minimum value eps=10⁻⁶, and initialized as

$$ki = \frac{{s}_{max}}{‖ \vec{e} - \vec{p} ‖} ,$$

after which the iterative solving process begins. sₘₐₓ represents the maximum allowable displacement, and ∥\vec{e}−\vec{p}∥ represents the straight-line distance from the current point p to the endpoint e.

Step S1644: substitute the current iteration value into the loss function corresponding to the target equation and into the gradient function of the loss function, and compute the current loss value and gradient value.

In this embodiment, the loss function may be:

$$Loss ( k ) = 2 * ‖ \vec{cp} ‖ * {Y}_{1} * ( 1 - {Y}_{2} ) + {( k * d )}^{2} - {s}_{max}^{2}$$

where the loss function measures the squared difference between the displacement predicted by the current Ki and the maximum allowable displacement.

In the formula, Y_{1˜3} represents a temporary variable in the calculation process:

$${Y}_{1} = ‖ \vec{cp} ‖ + k * d , {Y}_{2} = cos ( k * α ) , {Y}_{3} = sin ( k * α ) .$$

Specifically, Y1 may represent the expected radius at the next moment, Y2 may represent the cosine value of the expected rotation angle, and Y3 may represent the sine value of the expected rotation angle.

In this embodiment, the gradient function may be:

$$∇ Loss ( k ) = 2 * ( d * {Y}_{1} - ‖ \vec{cp} ‖ * d * {Y}_{2} + ‖ \vec{cp} ‖ * {Y}_{1} * {Y}_{3} * α )$$

where the gradient value represents the rate of change (derivative) of the loss function at the current ki, that is, in order to reduce the loss, in which direction (increase or decrease) and with what step size Ki should be adjusted.

Step S1646: based on the current loss value and gradient value, determine whether the preset iterative convergence conditions are satisfied.

In this embodiment, the preset convergence conditions may include two conditions, and satisfying either one is sufficient:

Gradient convergence, |Δk|<eps, where eps may be a very small positive value, indicating that the gradient at the current point is nearly zero and the function value is near an extremum.

Step-size convergence, |∇Loss(ki)|<eps, where

$$Δ k = \frac{Loss ( ki )}{∇ Loss ( ki )}$$

indicating that the update step computed in this iteration is already very small, and the improvement of the parameter is negligible, and further iteration is unnecessary.

Step S1648: if the iterative convergence conditions are satisfied, output the current iteration value as the solution of the motion constraint parameter; if the iterative convergence conditions are not satisfied, update the iteration value of the motion constraint parameter based on the current loss value and gradient value, and return to continue the iterative calculation process until the iterative convergence conditions are met or the maximum number of iterations is reached.

In this embodiment, if either of the above convergence conditions is satisfied, the iteration is immediately terminated, and the current iteration variable ki is output as the final solution. This final solution is the optimal motion constraint parameter k for the current control period.

In this embodiment, if the convergence conditions are not satisfied, the Newton iteration method may be used to update the solution. The updated ki is then used as the new current iteration value, and the process returns to Step S1644 to recalculate the loss and gradient and perform the next round of convergence checking.

In this embodiment, the loop process may further be configured with a maximum number of iterations as a safety measure, preventing infinite loops under abnormal conditions and ensuring the real-time performance of the algorithm.

By adopting a standardized iterative procedure to solve the target equation, this embodiment achieves the beneficial effect of transforming a complex nonlinear equation-solving problem into an automatically executable and stably convergent numerical computation process. Through feedback information such as gradients, the search direction is dynamically adjusted to ensure solving accuracy and efficiency, enabling the real-time output of an optimal parameter that strictly satisfies kinematic constraints in each control cycle. Meanwhile, the modular design grants the algorithm excellent universality, allowing flexible adaptation to different forms of target equations.

This embodiment provides a method for determining a position point, where the execution subject of the method may be the processing unit of a robot, such as an embedded controller, an industrial computer, a dedicated motion control card, or a real-time computing module integrated into the robot system.

The method may include:

Step S22: using the method for determining the motion constraint parameter described in the above embodiments to compute the motion constraint parameter of the current control cycle.

Step S24: based on the motion constraint parameter, the total rotation angle, the total radius variation, and the third position point, computing the next position point to which the controlled object should move during the current control cycle.

This embodiment provides a method for generating a motion control signal, where the execution subject may be a hardware unit directly responsible for low-level motion control of the robot, such as a motion controller or a servo driver.

The method may include:

Step S32: using the method for determining the position point described in the above embodiments to compute the next position point;

Step S34: based on the next position point, generating a motion control signal for controlling the controlled object.

This embodiment provides a method for controlling a controlled object, where the execution subject may be a hardware unit directly responsible for low-level motion control of the robot, such as a motion controller or a servo driver.

The method may include:

Step S42: using the method for generating the motion control signal described in the above embodiments to generate the motion control signal;

Step S44: sending the motion control signal to the actuator of the controlled object to drive the controlled object to move to the next position point.

In this embodiment, the actuator of the controlled object may be a servo motor, a stepper motor, or a hydraulic or pneumatic actuator, among others.

In a specific implementation, a variable-radius arc motion planning method is provided.

It can be understood that existing arc motion planning technologies (such as those used in industrial/collaborative robots and CNC machine tools) generally require predefining the arc center and radius, or any three points on the arc, to achieve fixed-radius arc motion planning. Such designs face the following practical limitations:

Motion efficiency issue: in fixed-radius arc motion planning, when the distances from the starting point, endpoint, and center are not equal, segmented and multiple path adjustments are required, which significantly increases computational complexity and time consumption and may lead to redundant or discontinuous paths;

Limited application scenarios: fixed-radius arc motion cannot accommodate scenarios where the arc center position changes during motion or where the radius needs to vary. For example, in irregular surface machining tasks or dynamic obstacle-avoidance tasks, fixed-radius arc motion cannot fulfill the requirements.

Compared with the fixed-radius arc motion planning, the variable-radius arc motion planning not only effectively solves the above-mentioned practical pain points, but can also be widely applied in many scenarios. For example, in orthopedic surgical robots, during the process of moving from the current pose to the target pose, it is often necessary to bypass obstacles to reach the target safely. Variable-radius arc motion planning can optimize path smoothness and improve the safety and fluency of surgical operations.

To address the shortcomings of the existing technologies, the objective of this embodiment is to provide a variable-radius arc motion planning method, which meets the practical application requirements in the field of motion planning technology.

This embodiment relates to a motion planning method in three-dimensional space. For illustration, the drawings below use two-dimensional schematic diagrams. FIG. 2 illustrates the difference between a fixed-radius arc and a variable-radius arc; FIG. 3 illustrates the advantages of variable-radius arcs in motion efficiency; and FIGS. 4 and 5 illustrate the advantages of variable-radius arcs in dynamic obstacle avoidance.

This embodiment proposes a variable-radius arc motion planning method, which belongs to real-time motion planning methods. The overall procedure is as follows:
Step 1: before motion starts, define the control cycle and the maximum linear velocity;
Step 2: take the starting point as the current point and begin motion planning;
Step 3: based on the current point and the arc center and endpoint specified at the current control time, compute the total rotation angle and total radius change;
Step 4: based on the current point, arc center, total rotation angle, and total radius change, compute the constraint factor that satisfies the control cycle and maximum linear velocity constraints;
Step 5: based on the constraint factor, compute the control point for the next control cycle;
Step 6: treat the control point of the next control cycle as the control command for motion control;
Step 7: use the control point computed in the previous step as the new current point, return to Step 3, and continue motion planning until the current point coincides with the endpoint, concluding the motion planning.

A flowchart of the overall method is shown in FIG. 6.

In Step 3, let the coordinates of the current point in three-dimensional space be denoted as \vec{p}, the coordinates of the arc center as \vec{c}, and the coordinates of the endpoint as \vec{e}. Define directional vectors:

$$\vec{cp} = \vec{p} - \vec{c}$$

$$\vec{ce} = \vec{e} - \vec{c}$$

It is clear that \vec{cp} is the vector from the arc center to the current point, and \vec{ce} is the vector from the arc center to the endpoint. Then the rotation axis represented by the unit directional vector \vec{axis} may be calculated by the following formula:

$$\vec{axis} - \frac{\vec{cp} \times \vec{ce}}{‖ \vec{cp} \times \vec{ce} ‖}$$

It is not difficult to understand that \vec{axis} is the normal vector perpendicular to the plane formed by \vec{p}, \vec{c}, and \vec{e}.

The variable α representing the total rotation angle may be computed using the following formula:

$$α = atan 2 ( ‖ \vec{cp} \times \vec{ce} ‖ , ‖ \vec{cp} \cdot \vec{ce} ‖ )$$

The variable d representing the total radius change may be computed using the following formula:

$$d = ‖ \vec{ce} ‖ \to ‖ \vec{cp} ‖$$

Related variables are shown in FIG. 7.

The above calculations can be represented using the following function Dist( ).

$$[ \vec{axis} , α , d ] = Dist ( \vec{p} , \vec{c} , \vec{e} ) .$$

In Step 5, the control point of the next control cycle can be computed based on the constraint factor as follows.

To ensure synchronized completion of the rotation angle αᵣₒₜ and radius change d_{inch}, the rotation angle and radius change of the control point relative to the current point at the next control time should both be equal to the constraint factor multiplied by the total rotation angle and total radius change. That is, if the constraint factor is denoted as K (k∈[0,1]), then:

$${α}_{rot} = k * α$$

$${d}_{inch} = k * d$$

In other words, the control point of the next control cycle should be generated from the current point \vec{p}, relative to the arc center \vec{c}, by rotating around the rotation axis \vec{axis} by the rotation angle αᵣₒₜ and applying the radius change d_{inch}. Therefore, the control point can be computed as follows:

First, compute the vector \vec{cp} rotated around rotation axis \vec{axis} by rotation angle αᵣₒₜ to obtain vector \vec{cp}ᵣₒₜ.

$${\vec{cp}}_{rot} = \vec{cp} + sin ( {α}_{rot} ) \cdot \vec{axis} \times \vec{cp} + ( 1 - cos ( {α}_{rot} ) ) \cdot \vec{axis} \times ( \vec{axis} \times \vec{cp} )$$

Second, along the direction of vector \vec{cp}ᵣₒₜ, perform a radius change of length d_{inch} to compute the vector \vec{cp}_{inch} after the radius change d_{inch}:

$${\vec{cp}}_{inch} - \frac{‖ {\vec{cp}}_{rot} ‖ + {d}_{inch}}{‖ {\vec{cp}}_{rot} ‖} * {\vec{cp}}_{rot}$$

Here,

$$\frac{‖ {\vec{cp}}_{rot} ‖ + {d}_{inch}}{‖ {\vec{cp}}_{rot} ‖}$$

is essentially a scaling factor applied to \vec{cp}ᵣₒₜ, scaling its length. d_{inch} may be positive or negative.

Finally, the control point \vec{p}_{inch} for the next control cycle is generated as:

$${\vec{p}}_{inch} = \vec{c} + {\vec{cp}}_{inch}$$

Relevant variables are shown in FIG. 8.

The above calculation process can be represented by the following function Inch( ):

$$[ {\vec{p}}_{inch} ] = Inch ( k , α , d , \vec{cp} , \vec{axis} , \vec{c} )$$

Since [\vec{axis}, α, d]=Dist(\vec{p},\vec{c},\vec{e}) and \vec{cp}=\vec{p}−\vec{c}, the function Inch( ) can be further simplified as:

$$[ {\vec{p}}_{inch} ] = Inch ( k , \vec{p} , \vec{c} , \vec{e} )$$

From the simplified form of the function Inch( ), it can be seen that when the current point, arc center, and endpoint are known, the control point of the next control cycle is a function uniquely dependent on the constraint factor K.

In Step 5, the constraint factor that satisfies the control cycle and maximum linear velocity constraints can be computed based on the current point, arc center, total rotation angle, and total radius change.

Assume that the given control cycle is denoted as Δt, and the maximum linear velocity is denoted as vₘₐₓ. When ignoring the acceleration and deceleration processes during motion, the maximum straight-line sₘₐₓ distance between the current point \vec{p} and the next control point \vec{p}_{inch} should be:

$${s}_{max} = {v}_{max} * Δ t$$

According to the law of cosines, when the lengths of two sides and their included angle of a triangle are known, the length of the third side can be calculated. Thus, for the triangle composed of the current point \vec{p}, arc center \vec{c}, and the next control point \vec{p}_{inch}, the straight-line distance ∥\vec{pp}_{inch}∥ between the current point \vec{p} and the next control point \vec{p}_{inch} satisfies the following formula:

$${‖ {\vec{pp}}_{inch} ‖}^{2} = {‖ \vec{cp} ‖}^{2} + {‖ {\vec{cp}}_{inch} ‖}^{2} - 2 * ‖ \vec{cp} ‖ * ‖ {\vec{cp}}_{inch} ‖ * cos ( {α}_{rot} )$$

It is clear that in the above formula \vec{pp}_{inch}=\vec{p}_{inch}−\vec{p}. In addition, to perform motion planning at the maximum linear velocity for improved efficiency, the following should also hold:

$$‖ {\vec{pp}}_{inch} ‖ = {s}_{max}$$

Thus, the formula becomes:

$${s}_{max}^{2} = {‖ \vec{cp} ‖}^{2} + {‖ {\vec{cp}}_{inch} ‖}^{2} - 2 * ‖ \vec{cp} ‖ * ‖ {\vec{cp}}_{inch} ‖ * cos ( {α}_{rot} )$$

Relevant variables are shown in FIG. 9.

By substituting variable values such as αᵣₒₜ=k*α, d_{inch}=k*d, the unknown variable \vec{p}_{inch} can be eliminated, and the above formula can be simplified into a unary transcendental equation with respect to the constraint factor K:

$${s}_{max}^{2} = 2 * ‖ \vec{cp} ‖ * ( ‖ \vec{cp} ‖ + k * d ) * ( 1 - cos ( k * α ) ) + {( k * d )}^{2}$$

Based on this simplified form, the following loss function Loss(k) and its gradient function ∇Loss(k) are proposed for iterative solving of the constraint factor K:

$$Loss ( k ) = 2 * ‖ \vec{cp} ‖ * {Y}_{1} * ( 1 - {Y}_{2} ) + {( k * d )}^{2} - {s}_{max}^{2}$$

$$∇ Loss ( k ) = 2 * ( d * {Y}_{1} - ‖ \vec{cp} ‖ * d * {Y}_{2} + ‖ \vec{cp} ‖ * {Y}_{1} * {Y}_{3} * α )$$

where Y_{1˜3} represents temporary variables during the calculation:

$${Y}_{1} = ‖ \vec{cp} ‖ + k * d , {Y}_{2} = cos ( k * α ) , {Y}_{3} = sin ( k * α )$$

Let Ki be the iterative variable, with minimum value eps=10⁻⁶, initialize

$$ki = \frac{{s}_{max}}{‖ \vec{e} - \vec{p} ‖} ,$$

and begin iterative solving:

Step 101: substitute ki into the formulas of the loss function and gradient function to compute Loss(ki), ∇Loss(ki).

Step 102: if |∇Loss(ki)|<eps, the iteration is considered to have converged to the final value, and the process may end and jump to Step 105; otherwise, compute the difference value

$$Δ k = \frac{Loss ( ki )}{∇ Loss ( ki )}$$

of the iterative variable;

Step 103: if |Δk|<eps, the iteration is also considered to have converged to the final value, and the process may end and jump to Step 105; otherwise, update Ki as: kì=ki−Δk;

Step 104: constrain Ki within the range of [0, 1]: ki=max(min(ki, 1), 0), then return to Step 101;

Step 105: obtain the iterative variable ke=ki of the final iteration, and end the iteration.

The resulting ke obtained after the iteration ends is the true value of the constraint factor K corresponding to the control point of the next control cycle. Substituting it back into the function Inch( ) yields the position of the control point \vec{p}_{inch} for the next control cycle that satisfies the control cycle and maximum linear velocity constraints.

A practical example is provided to further illustrate the effect achieved by this embodiment.

The starting point is [400, −100, 300], the endpoint is [100, 100, 600] and the arc center is [0, 0, 500], all in units of mm; the maximum linear velocity is 500 mm/s, and the control cycle is 20 ms. The control points planned by the variable-radius arc motion planning method proposed in this disclosure are shown in FIG. 10: the values of the constraint factor K corresponding to the control points from the starting point to the endpoint are shown in FIG. 11. In practical applications, the control points are the output of motion planning and may be sent as position control commands to motion execution devices, such as industrial robots or collaborative robots, to perform position-mode motion; position commands may also be differentiated over time to obtain velocity control commands for velocity-mode motion.

In this embodiment, the process of solving the constraint factor K can be simplified. For example, the term cos(k*α) in the unary transcendental equation can be expanded using a Taylor series while retaining only the quadratic term, converting it into a form of

$$1 - \frac{{( k * α )}^{2}}{2} .$$

This further simplifies the transcendental equation into a cubic equation with respect to the constraint factor K:

$${s}_{max}^{2} = d * ‖ \vec{cp} ‖ * {α}^{2} * {k}^{3} + ( {d}^{2} + {‖ \vec{cp} ‖}^{2} * {α}^{2} ) * {k}^{2}$$

Conventional methods for solving cubic equations, such as Cardano's method or Shengjin's formula, may be used to directly solve the equation, selecting the real root within [0,1]. Obtaining an approximate value of the constraint factor K using a radical-formula solution can simplify the computational process and accelerate solving speed. However, it is not difficult to understand that this will incur some loss of accuracy. This approach may be considered when computational resources are limited and high precision is not required.

Additionally, further motion constraints, such as maximum linear acceleration, may be introduced to further optimize the solving process of the constraint factor K so as to account for the influence of acceleration and deceleration on motion planning.

According to embodiments of the present disclosure, an electronic device is provided. The electronic device in this embodiment may include one or more of the following components: a processor, a network interface, a memory, a non-volatile storage, and one or more applications, where the one or more applications may be stored in the non-volatile storage and configured to be executed by one or more processors, and one or more programs are configured to execute the methods described in the foregoing method embodiments.

According to embodiments of the present disclosure, a computer-readable storage medium is provided. A computer program is stored on the medium, and when executed by a computer, causes the computer to perform the method described in any one of the preceding embodiments.

According to embodiments of the present disclosure, a computer program product containing instructions is further provided. When executed by a computer, the instructions cause the computer to perform any one of the methods in the preceding embodiments.

It should be noted that the terms “first,” “second,” and the like in the description, claims, and drawings of the present application are used solely to distinguish similar objects and do not necessarily describe a particular sequence. It should be understood that such data may be interchanged under appropriate circumstances so that the embodiments of the present application described herein may be implemented in an order other than that illustrated or described. Furthermore, the terms “including” and “having,” and any variations thereof, are intended to cover non-exclusive inclusion. For example, a process, method, system, product, or device that includes a series of steps or units is not limited to those clearly listed but may also include other steps or units not explicitly listed or inherent to such processes, methods, products, or devices.

Optionally, specific examples in this embodiment may refer to examples described in the above embodiments, and repetition is omitted here.

The numbering of the embodiments in this application is solely for descriptive purposes and does not indicate superiority or inferiority of the embodiments.

In the above embodiments of this application, each embodiment emphasizes different aspects. Parts not described in detail in one embodiment may be referenced from related descriptions in other embodiments.

The above descriptions are merely preferred embodiments of this application. It should be noted that, for those skilled in the art, improvements and modifications may be made without departing from the principles of this application, and these improvements and modifications shall also fall within the protection scope of this application.

What is claimed is:

1. A method for determining motion constraint parameters, comprising:
acquiring a first position point, a second position point, and a third position point of a current control cycle; wherein the first position point represents a current position point at which a controlled object is located, the second position point represents a target end position point to which the controlled object needs to move, and the third position point represents a center-of-circle position point;
based on the first position point, the second position point, and the third position point, calculating a total rotation angle and a total radius variation required for the controlled object to move from the first position point to the second position point along a variable-radius arc trajectory;
based on the total rotation angle, the total radius variation, the first position point, the second position point, and a preset solving algorithm for motion constraint parameters, determining the motion constraint parameters of the current control cycle; wherein the motion constraint parameters are used for calculating a next position point to which the controlled object should move within the current control cycle, and the determination of the motion constraint parameters enables the movement between the next position point and the first position point to satisfy at least one motion constraint condition.

2. The method according to claim 1, wherein the acquiring the first position point, the second position point, and the third position point of the current control cycle comprises:
reading the first position point, the second position point, and the third position point of the current control cycle from path planning data pre-stored in a memory; or
receiving the first position point, the second position point, and the third position point of the current control cycle collected and transmitted by at least one external sensor; or
receiving real-time position commands sent from an external control device and parsing the real-time position commands to obtain the first position point, the second position point, and the third position point of the current control cycle.

3. The method according to claim 1, wherein the calculating the total rotation angle and the total radius variation required for the controlled object to move from the first position point to the second position point along the variable-radius arc trajectory based on the first position point, the second position point, and the third position point comprises:
calculating a first vector pointing from the third position point to the first position point, and calculating a second vector pointing from the third position point to the second position point;
calculating the total rotation angle according to a modulus of a cross product of the first vector and the second vector and a dot product of the first vector and the second vector;
calculating a difference between a modulus of the second vector and a modulus of the first vector to obtain the total radius variation.

4. The method according to claim 1, wherein the determining the motion constraint parameters of the current control cycle based on the total rotation angle, the total radius variation, the first position point, the second position point, and the preset solving algorithm for motion constraint parameters comprises:
inputting the total rotation angle, the total radius variation, the first position point, and the second position point into a pre-constructed target equation with respect to the motion constraint parameters; wherein the target equation is constructed such that a solution to the target equation is the motion constraint parameters, and under constraint of the motion constraint parameters, a kinematic relationship of the controlled object moving from the first position point to the next position point satisfies at least one motion constraint condition;
adopting the preset solving algorithm to solve the target equation to obtain the motion constraint parameters of the current control cycle.

5. The method according to claim 4, wherein the motion constraint conditions comprise: a maximum linear velocity constraint, a maximum angular velocity constraint, a maximum linear acceleration constraint, a maximum angular acceleration constraint, or a maximum jerk constraint.

6. The method according to claim 4, wherein the preset solving algorithm comprises: a gradient-based iterative optimization algorithm, a derivative-free iterative search algorithm, an optimization algorithm with global search capability, a table-lookup and interpolation method, or a data-driven optimization algorithm.

7. The method according to claim 4, wherein when the motion constraint condition is the maximum linear velocity constraint, the target equation is constructed to characterize the following relationship:
under the constraint of the motion constraint parameters, a magnitude of a displacement generated by moving from the first position point to the next position point is equal to the predetermined maximum linear velocity multiplied by the control cycle; wherein a geometric relationship among the magnitude of the displacement, the total rotation angle, and the total radius variation is determined based on angular and side relationships of a triangle formed by the first position point, the third position point, and the next position point.

8. The method according to claim 7, wherein the adopting the preset solving algorithm to solve the target equation to obtain the motion constraint parameters of the current control cycle comprises:
initializing an iterative initial value of the motion constraint parameters;
substituting a current iterative value into a loss function corresponding to the target equation and a gradient function of the loss function to calculate a current loss value and a gradient value;
determining whether a preset iterative convergence condition is satisfied based on the current loss value and the gradient value;
when the convergence condition is satisfied, outputting the current iterative value as the solution of the motion constraint parameters; and
when the convergence condition is not satisfied, updating the iterative value of the motion constraint parameters based on the current loss value and the gradient value, and returning to continue the iterative computation process until the convergence condition is satisfied or a maximum number of iterations is reached.

9. A method for determining a position point, comprising:
adopting the method for determining motion constraint parameters according to claim 1 to calculate the motion constraint parameters of the current control cycle; and
based on the motion constraint parameters, the total rotation angle, the total radius variation, and the third position point, calculating the next position point to which the controlled object should move within the current control cycle.

10. A method for generating a motion control signal, comprising:
adopting the method for determining a position point according to claim 9 to calculate the next position point; and
based on the next position point, generating a motion control signal for controlling the controlled object.

11. A method for controlling a controlled object, comprising:
adopting the method for generating a motion control signal according to claim 10 to generate the motion control signal; and
sending the motion control signal to an actuator of the controlled object to drive the controlled object to move to the next position point.

12. An electronic device, comprising:
a memory and one or more processors communicatively connected to the memory;
wherein the memory stores instructions executable by the one or more processors, and the instructions, when executed by the one or more processors, enable the one or more processors to implement the method for determining motion constraint parameters according to claim 1.

13. An electronic device, comprising:
a memory and one or more processors communicatively connected to the memory;
wherein the memory stores instructions executable by the one or more processors, and the instructions, when executed by the one or more processors, enable the one or more processors to implement the method for determining a position point according to claim 9.

14. An electronic device, comprising:
a memory and one or more processors communicatively connected to the memory;
wherein the memory stores instructions executable by the one or more processors, and the instructions, when executed by the one or more processors, enable the one or more processors to implement the method for generating a motion control signal according to claim 10.

15. An electronic device, comprising:
a memory and one or more processors communicatively connected to the memory;
wherein the memory stores instructions executable by the one or more processors, and the instructions, when executed by the one or more processors, enable the one or more processors to implement the method for controlling a controlled object according to claim 11.

16. A non-transitory computer-readable storage medium, wherein a computer program is stored on the non-transitory computer-readable storage medium, and when the computer program is executed by a processor, the method for determining motion constraint parameters according to claim 1 is implemented.

17. A non-transitory computer-readable storage medium, wherein a computer program is stored on the non-transitory computer-readable storage medium, and when the computer program is executed by a processor, the method for determining a position point according to claim 9 is implemented.

18. A non-transitory computer-readable storage medium, wherein a computer program is stored on the non-transitory computer-readable storage medium, and when the computer program is executed by a processor, the method for generating a motion control signal according to claim 10 is implemented.

19. A non-transitory computer-readable storage medium, wherein a computer program is stored on the non-transitory computer-readable storage medium, and when the computer program is executed by a processor, the method for controlling a controlled object according to claim 11 is implemented.
